(19) United States
(12) Patent Application Publication
(10) Pub. No.: US 2004/0107381 A1
(43) Pub. Date: Jun. 3, 2004

(54) High performance transaction storage and retrieval system for commodity computing environments

(75) Inventors: Joanes DePaula Bomfim, McLean, VA (US); Richard Stephen Rothstein, McLean, VA (US)

Correspondence Address: STAAS & HALSEY LLP, SUITE 700, 1201 NEW YORK AVENUE, N.W., WASHINGTON, DC, 20005, US

(73) Assignee: American Management Systems, Incorporated, Fairfax, VA

(21) Appl. No.: 10/193,671

(22) Filed: Jul. 12, 2002

(51) Int. Cl. G06F 7/00

(52) U.S. Cl. 714/4

(57) ABSTRACT

A high performance transaction storage and retrieval system supports an enterprise application requiring high volume transaction processing using commodity computers meeting business processing time budget requirements. The transaction storage and retrieval system is coupled to servers. The transaction storage and retrieval system includes input/output processes corresponding respectively to the servers and receiving transaction data from the servers, a memory, coupled to the input/output processes, receiving the transaction data from the input/output processes and storing the transaction data, disk writers coupled to the memory and corresponding respectively to the servers, and subpartition storage, coupled to the disk writers. The disk writers read the transaction data from the memory and store the transaction data in the subpartition storage. The subpartition storage is organized as flat files, each subpartition storage storing data corresponding to a subpartition of the transaction data.

### CROSS REFERENCE TO RELATED APPLICATIONS

This application is related to GAP DETECTOR DETECTING GAPS BETWEEN TRANSACTIONS TRANSMITTED BY CLIENTS AND TRANSACTIONS PROCESSED BY SERVERS, U.S. Ser. No. 09/922,698, filed Aug. 7, 2001, the contents of which are incorporated herein by reference.

This application is related to AN IN-MEMORY DATABASE FOR HIGH PERFORMANCE, PARALLEL TRANSACTION PROCESSING, attorney docket no. 1330.1110/GMG, U.S. Serial No.______, by Joanes Bomfim and Richard Rothstein, filed concurrently herewith, the contents of which are incorporated herein by reference.

This application is related to HIGH PERFORMANCE DATA EXTRACTING, STREAMING AND SORTING, attorney docket no. 1330.1113P, U.S. Serial No.______, by Joanes Bomfim, Richard Rothstein, Fred Vinson, and Nick Bowler, filed Jul. 2, 2002, the contents of which are incorporated herein by reference.

### BACKGROUND OF THE INVENTION

1. Field of the Invention

The present invention relates to high performance transaction storage and retrieval systems, more particularly, to high performance transaction storage and retrieval systems for commodity computing environments.

2. Description of the Related Art

Computer systems executing business applications are known in the art. One type of such computer systems processes high volumes of transactions on a daily, weekly, and/or monthly basis. In processing the high volumes of transactions, such computer systems engage in transaction processing and require high performance transaction storage and retrieval of data.

In addition, databases stored on disks and databases used as memory caches are known in the art. Moreover, in-memory databases, or software databases, generally, are known in the art, and support high transaction volumes. Data stored in databases is generally organized into records. The records, and therefore the database storing the records, are accessed when a processor either reads (queries) a record or updates (writes) a record.

To maintain data integrity, a record is locked during access of the record by a process, and this locking of the record continues throughout the duration of 1 unit of work and until a commit point is reached. Locking of a record means that processes other than the process accessing the record, are prevented from modifying the record. Upon reaching a commit point, the record is written to disk. If a problem with the record is encountered before the commit point is reached, then updates to that record and to all other records which occurred after the most recent commit point, are backed out and error processing occurs. That is, it is important for a database to enable commit integrity, meaning that if any process abnormally terminates, updates to records made after the most recent commit point are backed out and error processing is initiated.

After the unit of work is completed, the commit point is reached, and the record is successfully written to the disk, then the record lock is released (that is, the record is unlocked), and another process can access the record.

FIG. 1 shows a computer system 10 of the related art which executes a business application such as a telecommunication billing system. In the computer system 10 of the related art, a telephone switch 12 transmits telephone messages to a collector 14, which periodically (such as every ½ hour) transmits entire files 16 to an editor 18. Editor 18 then transmits edited files 20 to formatter 22, which transmits formatted files 24 to pricer 26, which produces priced records 28. The lag time between the telephone switch 12 transmitting the phone usage messages and the pricer 26 transmitting the priced records 28 is approximately ½ hour. Moreover, if there is a problem which requires recovery of the edited files 20 (for example), then further lag time is introduced into the system 10. In the computer system 10 shown in FIG. 1, the synchronization point (or synch point) is when the files are transmitted, such as when collector 14 transmits files 16 to an editor 18. A synchronization point or synchpoint refers to a database commit point or a data/file aggregate point in this document.

In a computer system which supports a high volume of transactions (such as the computer system 10 shown in FIG. 1), each transaction may initiate a process to access a record. Several records are typically accessed, and thus remain locked, over the duration of the time interval between commit points. Commit points are points in time when a record is written to disk. In current high volume transaction computer systems, for example, commit points can be placed every 10,000 transactions, and reached every 30 seconds.

Although it would be possible to place a commit point after each update to each record, doing so would add overhead to processing of the transactions, and thus slow the throughput of the computer system.

Transaction processing is typically performed in several steps, including inputting, processing, and storing/retrieving data. The last step in transaction processing is typically that of storing the transaction data in an enterprise repository, such as a database or a series of related or unrelated databases.

Conventional databases must reorganize periodically, which involves cycling through the database. Examples of conventional databases include disk subsystems such as RAID, IBM SHARK, and EMC², which are provided for general use.

Computer systems must make choices on how much to do during the step of storing the transaction data in an enterprise repository.

Writing the processed transactions to some form of sequential storage, without further processing of the data involved in the transactions, allows the transactions to be processed faster, but individual transactions in the repository are virtually inaccessible until further processing takes place. Further, when extremely high volumes of transactions are involved, simply storing transactions sequentially may be wasteful, since there may be too much data for the computer system to be able to afford to store the transactions more than just once.

Taking the time, on the other hand, to perform all database updates ensures that up-to-date data is available immediately after the transaction has been processed, but imposes a severe restriction on the rate at which transactions can be processed. In view of extremely high volumes of transactions, standard database software would be unable to keep up with the requests, except by a massive investment in hardware and software.

A factor which influences whether a database is suitable for a particular business application includes how fast data can be written to the database, which is based upon the speed of the physical disk to accept data. Currently, the maximum stream speed of a hard disk is approximately 50 MB (megabytes) per second. Another factor influencing the speed at which the database will accept the data includes the amount of movement of the disk arm required to write the data to the disk. A large amount of movement interrupts the flow of data to the disk.

For example, in a conventional database system, data is written to a disk in 50 KB (kilobyte) blocks. Writing each 50 KB block of data to the disk requires approximately 1 milliseconds of actual writing time, but requires an additional 5 milliseconds to find the correct spot to write the data. That is, approximately ⅚ of the time required to write data to a disk is used in positioning the disk arm to a spot on the disk to write the data. Conventionally, RAID and SHARK databases engage in data striping to reduce access time to the disk, but are optimized for the general case. Striping of data across a storage system improves speed for one specific user, but locks other users out of the storage system.

By way of another example using conventional disk systems such as a RAID system, a user is writing 300 KB of data to 6 disks in 50 KB blocks. From the user's perspective, the user appears to be writing 300 KB of data in 50 KB blocks of data to 6 disks in parallel. However, from the perspective of the computer system, 6 disks are being occupied at once by one user and are thus not usable by other users. Thus, from the perspective of the computer system, only ⅙ of the capability of the system is being used.

Conventional database software is not optimized for storing transaction data that is sequential in nature, has already been logged in a prior phase of processing, and does not require a level of concurrency protection provided by general purpose database software.

Conventional database software is general in purpose and makes no assumptions about the type of data that is being updated or inserted. All data is logged to allow recovery, access concurrency, repeatability of reads, hiding of uncommitted data, support for commits and backouts.

Moreover, database updates are typically random, even when data is inserted in sequential order, due to the sharing of disk devices by multiple tables and files. Databases are also typically difficult to tune to a high and consistent level of performance, but their selling points are many and well recognized.

Another database inefficiency across many processing phases is that the splitting the transaction data into, for example, multiple normalized tables, at transaction processing time, also works against some subsequent processes, such as billing. The billing process prefers that the transactions for the same account and accounts for the same bill cycle packed as close together as possible.

General purpose database systems in which the ability to control the placement of the data is taken away from an individual application in the interest of overall use of storage achieves overall performance goals. Just-in-time space allocation schemes work well for the entire system but do not provide the highest performance that is possible for a specific configuration of disk devices.

In addition, conventional databases that include threads for making requests, such as ORACLE databases, are known in the art. Moreover, communication channels, such as FICON channels, are known in the art.

A problem with the related art is that conventional database systems do not achieve the performance of the present invention for the high volumes of primarily sequential data targeted by the present invention.

### SUMMARY OF THE INVENTION

An aspect of the present invention is to provide a high performance transaction storage and retrieval system for commodity computing environments.

Another aspect of the present invention is to provide a high performance transaction storage and retrieval system in which transaction data is stored on partitions, each partition corresponding to a subset of an enterprise's entities or accounts, such as all accounts that belong to a particular bill cycle.

The above aspects can be attained by a system of the present invention, a high performance transaction storage and retrieval system (TSRS) supporting an enterprise application requiring high volume transaction processing using commodity computers meeting aggressive processing time requirements.

Moreover, the present invention comprises a high performance transaction storage and retrieval system supporting an enterprise application requiring high volume transaction processing using commodity computers by organizing transaction data into partitions, sequentially storing the transaction data, and sequentially retrieving the transaction data, the transaction data being organized, stored, and retrieved based upon business processing requirements.

The present invention comprises a transaction storage and retrieval system coupled to servers. The transaction storage and retrieval system includes input/output processes corresponding respectively to the data subpartitions and receiving transaction data from the servers, a memory, coupled to the input/output processes, receiving the transaction data from the input/output processes and storing the transaction data, disk writers coupled to the memory and corresponding respectively to the data subpartitions, and subpartition storage, coupled to the disk writers. The disk writers read the transaction data from the memory and store the transaction data in the subpartition storage. The subpartition storage is organized as flat files, each subpartition storage storing data corresponding to a sub partition of the transaction data.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 shows a computer system of the related art which executes a business application such as a telecommunication billing system.

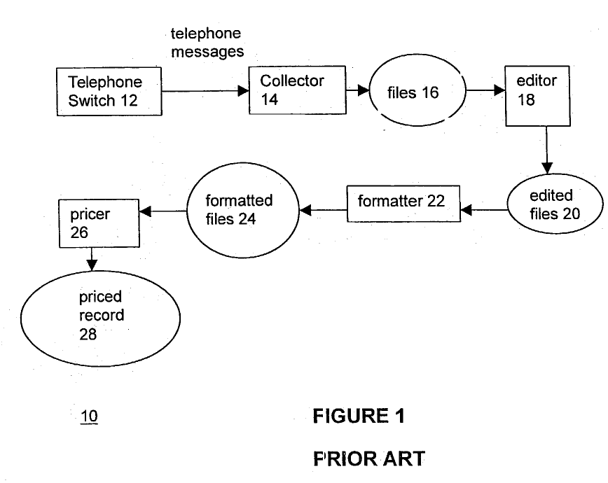

FIG. 2 shows major components of a computer system of the present invention including a high performance transaction support system.

FIG. 3 shows a sample configuration of clients, servers, the in-memory database, the gap analyzer, and the transaction storage and retrieval system.

FIG. 4 shows the configuration of the in-memory database and its associates.

FIG. 5 shows a reference configuration of the transaction storage and retrieval system of the present invention.

FIG. 6A shows assumptions on number of accounts, transaction volumes, number of machines, number and capacity of disk storage devices and other technical specifications.

FIG. 6B shows reference machine specifications.

FIG. 7 shows a diagram of a transaction storage and retrieval system of the present invention.

FIG. 8 shows a diagram of application server registration with the transaction storage and retrieval system of the present invention.

FIG. 9 shows a diagram of a partition or a subpartition index structure of the transaction storage and retrieval system of the present invention.

FIG. 10 shows a flow of synchpoint signals in a system including the transaction storage and retrieval system of the present invention.

FIG. 11 shows a failover cluster of transaction storage and retrieval system machines of the present invention paired for mutual backup.

FIG. 12 shows timing involved in periodic backup.

FIG. 13 shows a sequence of events for one processing cycle in a streamlined, 2-phase commit processing of the in-memory database, involving the transaction storage and retrieval system of the present invention and servers.

FIG. 14 shows an example of critical timings involved in exporting bill cycle partition data to a target machine on the billing date.

FIG. 15 shows an example of transaction storage and retrieval systems of the present invention with disk devices configured to meet a business process requirement.

FIG. 16 shows an example of the contents of an index file of the transaction storage and retrieval system of the present invention.

FIG. 17 shows a transaction storage and retrieval system of the present invention coupled to a disk box.

FIG. 18 shows a pair of transaction processing and retrieval systems of the present invention coupled to a disk box and to a switch.

### DETAILED DESCRIPTION OF THE PREFERRED EMBODIMENTS

The present invention includes a high performance transaction storage and retrieval system (TSRS) for commodity computing environments. The TSRS of the present invention supports an enterprise application requiring high-volume (that is, for example, 500,000,000 transactions per day, with about 10,000 transactions per second) processing using commodity computers meeting aggressive processing time requirements, including aggregating transaction and switching data for subsequent business processing within a predefined budget of time. The TSRS of the present invention is linearly scalable, and the performance of the TSRS of the present invention is optimized based upon the underlying enterprise computer architecture and application being executed by the enterprise computer. The TSRS of the present invention provides an optimization of storage.

An example is used to describe the present invention. The example is for a telecommunications billing system, with 500,000,000 transactions per day, each transaction being 1000 bytes long. In this example, the TSRS of the present invention, uses a Seagate Cheetah disk. The TSRS pre-allocates 36 files of a size of 2 gigabytes (GB) to a 72 GB disk, in memory between synchpoints. The pre-allocated files are reuseable, and the first four bytes of each pre-allocated file indicates the actual size of the file. Thus, in the TSRS of the present invention, de-fragmentation and reorganization of the database of the TSRS is unnecessary.

In the TSRS of the present invention, transaction data is stored on partitions, each partition corresponding to a major subset of an enterprise's entities or accounts, such as all the accounts that belong to a particular bill cycle.

Throughout the following disclosure, the terms “partition” and “bill cycle” may be used interchangeably. Depending on the configuration, a partition is often implemented as files on a number of TSRS machines, each one having its complement of disk storage devices.

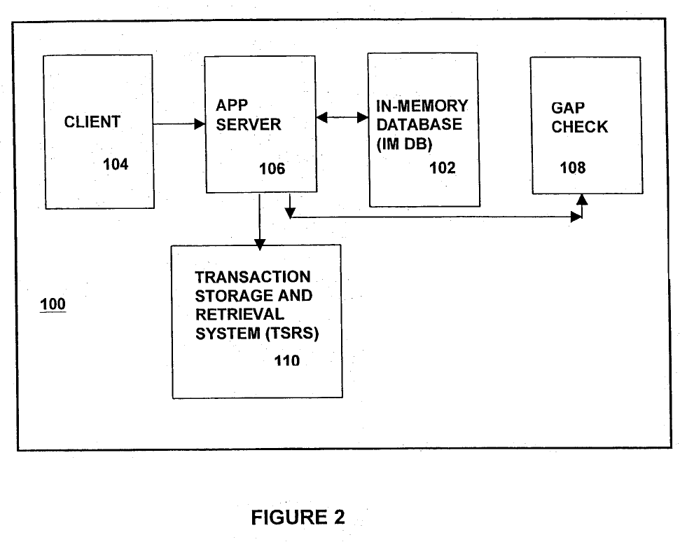

Before a detailed description of the present invention is presented, a brief overview is presented of a high performance transaction support system in which the present invention is included. The transaction storage and retrieval system (TSRS) of the present invention comprises a component in a suite of solutions for the end-to-end support of transaction processing in commodity computing environments of extremely high transaction rates and large numbers of processors. The placement of the TSRS component in that architecture is shown in FIG. 2.

FIG. 2 shows major components of a computer system including a high performance transaction support system 100.

The high performance transaction support system 100 shown in FIG. 2 includes an in-memory database (IM DB) 102. The high performance transaction support system 100 also includes a client computer 104 transmitting transaction data to an application server computer 106. Account queries and updates flow between the application server computer 106 and the in-memory database 102. Lists of processed transactions flow from the application server computer to the gap check (or gap analyzer) computer 108. The application server computer 106 also transmits the transaction data to the transaction storage and retrieval system 110 of the present invention. Although each of the above-mentioned in-memory database 102, client computer 106, gap check computer 108, and transaction storage and retrieval system 110 of the present invention is disclosed as being separate computers, one or more of the mentioned in-memory database 102, client computer 106, gap check computer 108, and transaction storage and retrieval system 110 of the present invention could reside on the same, or a combination of different, computers. That is, the particular hardware configuration of the high performance transaction support system 100 may vary.

The client computer 104, the application server computer 106, and the gap check computer 108 are disclosed in GAP DETECTOR DETECTING GAPS BETWEEN TRANSACTIONS TRANSMITTED BY CLIENTS AND TRANSACTIONS PROCESSED BY SERVERS, U.S. Ser. No. 09/922,698, filed Aug. 7, 2001, the contents of which are incorporated herein by reference.

The in-memory database (IM DB) 102 disclosed in AN IN-MEMORY DATABASE FOR HIGH PERFORMANCE, PARALLEL TRANSACTION PROCESSING, attorney docket no. 1330.1110, U.S. Serial No. ______, filed concurrently herewith, the contents of which are incorporated herein by reference.

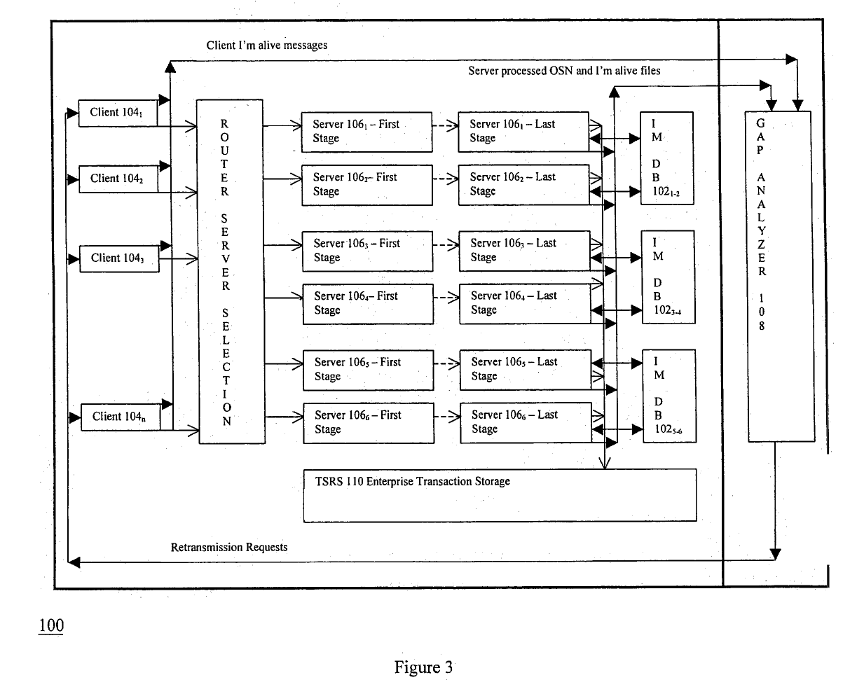

FIG. 3 shows a more detailed example of the computer system 100 shown in FIG. 2. The computer system 100 shown in FIG. 3 includes clients 104, servers 106, the in-memory database 102, the gap analyzer (or gap check) 108, and the transaction storage and retrieval system 110 of the present invention.

An example of data and control flow through the computer system 100 shown in FIG. 3 includes:

Client computers 104, also referred to as clients and as collectors, receive the initial transaction data from outside sources, such as point of sale devices and telephone switches (not shown in FIG. 3).

Clients 104 assign a sequence number to the transactions and log the transactions to their local storage so the clients 104 can be in a position to retransmit the transactions, on request, in case of communication or other system failure.

Clients 104 select a server 106 by using a routing program suitable to the application, such as by selecting a particular server 106 based on information such as the account number for the current transaction.

Servers 106 receive the transactions and process the received transactions, possibly in multiple processing stages, where each stage performs a portion of the processing. For example, server 106 can host applications for rating telephone usage records, calculating the tax on telephone usage records, and further discounting telephone usage records.

A local in-memory database 102 may be accessed during this processing. The local in-memory database 102 supports a subset of the data records maintained by the enterprise computer 100. As shown in FIG. 3, a local in-memory database 102 may be shared between servers 106 (such as being shared between 2 servers 106 in the example computer system 100 shown in FIG. 3).

When a transaction is processed by an application server 106, the transaction is forwarded to Transaction Storage and Retrieval System (TSRS) 110 of the present invention for long term storage. Typically, TSRS 110 of the present invention stores data by billing cycles rather than account numbers.

Periodically, during independent synchpoint processing phases, clients 104 generate short files including the highest sequence numbers assigned to the transactions that the clients 104 transmitted to the servers 106.

Also periodically, during the synchpoints, servers 106 make available to the gap analyzer 108 a file including a list of all the sequence numbers of all transactions that the servers 106 have processed during the current cycle. At this point, the servers 106 also prepare a short file including the current time to indicate the active status to the gap analyzer 108.

An explanation of the TSRS 110 of the present invention is presented in detail, after a brief overview of the gap analyzer 108 and a brief overview of the in-memory database 102.

Overview of the Gap Analyzer 108

The gap analyzer 108 applies to the high performance transaction support system 100 show in FIG. 2 by checking gaps in processed transactions and therefore picking up missing transactions.

The gap analyzer 108 wakes up periodically and updates its list of missing transactions by examining the sequence numbers of the newly arrived transactions. If a gap in the sequence numbers of the transactions has exceeded a time tolerance, the gap 108 analyzer issues a retransmission request to be processed by the affected client 104, requesting retransmission of the transactions corresponding to the gap in the sequence numbers. That is, the gap analyzer 108 receives server 106 information indicating which transactions transmitted by a client 104 through a computer communication network were processed by the server 106, and detects gaps between the transmitted transactions and the processed transactions from the received server information, the gaps thereby indicating which of the transmitted transactions were not processed by the server 106.

Overview of the In-Memory Database 102

An overview of the in-memory database 102 is now presented, with reference to the above-mentioned major components of the high performance transaction support system 100.

To achieve extremely high transaction rates in paralleled processing environments, the in-memory database system supports multiple concurrent clients (typically application servers, such as application server 106 shown in FIG. 2).

The in-memory database functions on the premise that most operations of the computer system in which the in-memory database resides complete successfully. That is, the in-memory database assumes that a record will be successfully updated, and thus, only commits after multiple updates. To achieve high concurrency, the in-memory database only locks the record for the relatively small period of time (approximately 10-20 milliseconds per transaction) that the record is being updated. Locking of a record means that processes other than the process accessing the record, are prevented from accessing the record.

The in-memory database, though, maintains commit integrity. If updating the record, for example, meets an abnormal end, then the in-memory database backs out the update to the record, and backs out the updates to other records, since the most recent commit point. The commits of the in-memory database are physical commits set at arbitrary time intervals of, for example, every 5 minutes. If there is a failure (an abnormal end), then transactions processed over the past 5 minutes, at most, would be re-processed.

The in-memory database includes a simple application programming interface (API) for query and updates, dedicated service threads to handle requests, data transfer through shared memory, high speed signaling between processes to show completion of events, an efficient storage format, externally coordinated 2-phase commits, incremental and full backup, pairing of machines for failover, mirroring of data, automated monitoring and automatic failover in many cases. In the present invention, all backups are performed through dedicated channels and dedicated storage devices, to unfragmented pre-allocated disk space, using exclusive I/O threads. Full backups are performed in parallel with transaction processing.

That is, the high performance in-memory database system 102 supports a high volume paralleled transaction system in the commodity computing arena, in which any synchronous I/O to or from disk storage would threaten to exceed a time budget allocated to process each transaction.

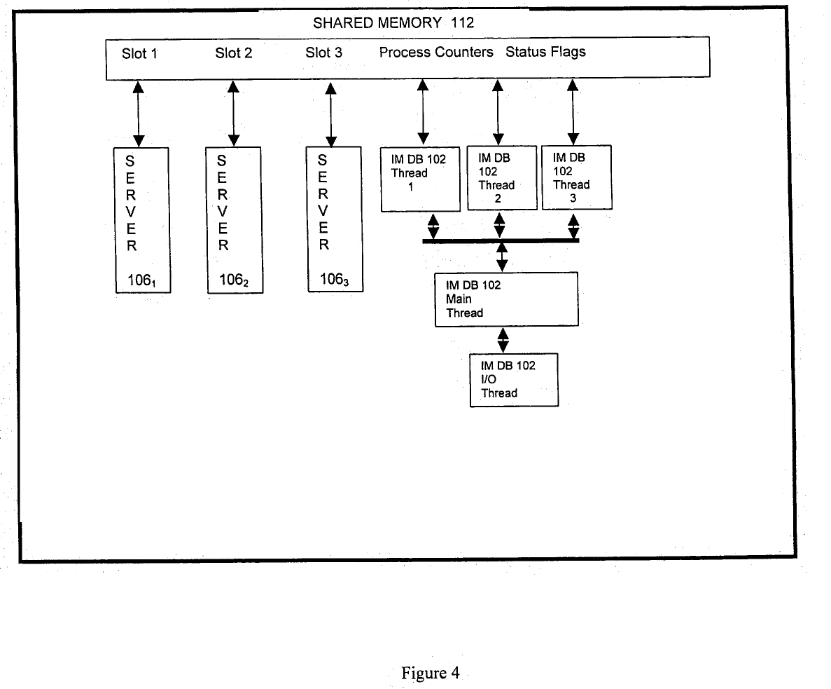

The general configuration of the in-memory database 102, and the relationship of the in-memory database 102 with servers 106, is illustrated in FIG. 4.

Typical requests made by transactions to the in-memory database 102 originate from regular application servers 106 that send queries or updates to a particular account. Requests can also be sent from an entity similar to an application server within the range of entities controlled by a process of the present invention.

On startup, the in-memory database process preloads its assigned database subset into memory before starting servicing requests from its clients 106 (not shown in FIG. 4). All of the clients 106 of the in-memory database 102 reside within the same computer under the same operating system image, and requests are efficiently serviced through the use of shared memory 112, dedicated service threads, and signals that indicate the occurrence of events.

Each instance of the in-memory database 102 maybe shared by several servers 106. Each server 106 is assigned to a communication slot in the shared memory 112 where the server 106 places the server's request to the in-memory database 102 and from which the server retrieves a response from the in-memory database 102. The request may be a retrieval or update request.

That is, application servers 106 use their assigned shared memory slots to send their requests to the in-memory database 102 and to receive responses from the in-memory database 102. Each server 106 has a dedicated thread within the in-memory database 102 to attend to the server's requests.

The in-memory database 102 includes a separate I/O thread to perform incremental and full backups. The shared memory 112 is also used to store global counters, status flags and variables used for interprocess communication and system monitoring.

In a high performance computer system which includes an in-memory database, machines (such as application servers 106 and in-memory databases 102) are paired up to serve as mutual backups. Each machine includes local disk storage sufficient to store its own in-memory database as well as to hold a mirror copy of its partner's databases of the in-memory database.

Transaction Storage and Retrieval System of the Present Invention

The transaction storage and retrieval system (TSRS) 110 of the present invention is now disclosed.

Overview of the Transaction Storage and Retrieval System of the Present Invention

The TSRS 110 architecture takes advantage of the combined high processing and storage capacity of a large number of commodity computers, operating in parallel, to (1) shorten the time taken to store a transaction that has just been processed and, at the same time, store it in a way that will also (2) shorten the subsequent periodic batch processes, such as billing and similar operations.

The TSRS 110 architecture includes an efficient configuration and deterministic processes and strategies to ensure that a short and consistent response time is achieved during the storage of transactions. Moreover, the degree of intelligence in the storage phase of the TSRS 110 includes think-ahead features that address the issue of how to extract the extremely high volumes of stored transactions to allow subsequent batch processes to be completed in the available processing windows. These think-ahead features apply to storage of data, and to sequential retrieval of high volumes of data and subsequent requirements for processing of the high volumes of data.

In addition, the transaction data addressed by the TSRS 110 is sequential in nature, has already been logged in a prior phase of the processing, and typically does not require the level of concurrency protection provided by general purpose database software. The architecture of the TSRS 110 controls the use of disk storage to a much higher level than would be possible by relying solely on commercially available disk array systems. That is, the TSRS 110's use of its disk storage is based on dedicated devices and channels on the part of owning processes and threads, such that contention for the use of a device takes place only infrequently.

The TSRS 110 is a high performance transaction storage and retrieval system for commodity computing environments. Transaction data is stored on partitions, each partition corresponding to a subset of an enterprise's entities or accounts, such as for example all the accounts that belong to a particular bill cycle. More specifically, a partition is implemented as files on a number of TSRS 110 machines, each one having its complement of disk storage devices.

The transaction storage and retrieval system 110 of the present invention also includes a routing program that determines data placement into partitions and subpartitions. The routing program considers load balancing and grouping of business data for subsequent business processing when determining the placement of the data.

Each one of the machines in a partition holds a subset of the partition data and this subset is referred to as a subpartition. When an application server 106 (or requestor) finishes processing a transaction and contacts the TSRS 110 to store the transaction data, a routing program directs the data to the machine that is assigned to that particular subpartition. The routing program uses the transaction's key fields such as an account number and thus ensures that transactions for the same account are stored in the same subpartition. The program is flexible and allows for transactions for very large accounts to span more than one machine. Moreover, the routing program determines data placement into partitions by considering load balancing and grouping of business data for subsequent business processing. For example, the routing program of the TSRS of the present invention could be optimized for extracting data in a billing application in which a relatively low number of users support a low volume query.

The routing program as well as all the software to issue requests to the TSRS 110 is included in the present invention and is provided as an add-on to be linked to the application server 106 process. This add-on is referred to as a requester. Therefore, the processes included in the TSRS 110 of the present invention interact only with requestors and not directly with the application servers 106. However, throughout the following discussion, the terms requesters and application servers may be used interchangeably.

Within each TSRS 110 machine, multiple independent processes, called Input/Output Processors (IOPs) service the requests transmitted to them by their partner requestors. On each TSRS 110 machine, there is a dedicated IOP for each data subpartition Each IOP handles a particular range of keys and it is shared by all application server/requestor that are active in the transaction processing system. IOPs are started as part of bringing up the TSRS system or on-demand when they are first needed.

When application servers 106 perform their periodic synchpoints, they direct the TSRS 110 to participate in the synchpoint operation; this ensures that the application servers's 106 view of the transactions that they have processed and committed is consistent with the TSRS 110's view of the transaction data that it has stored.

Detailed Description of the Transaction Storage and Retrieval System of the Present Invention

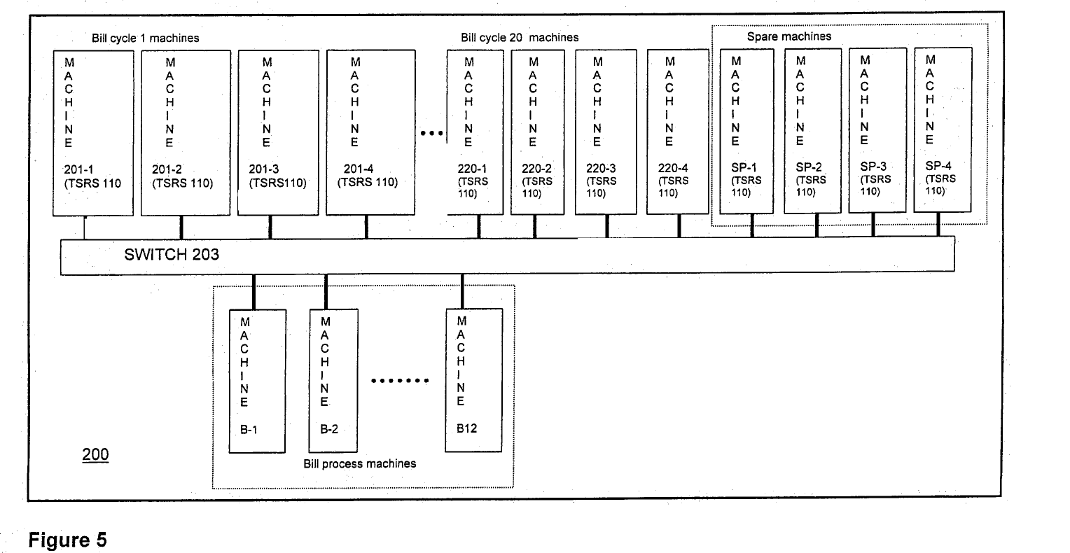

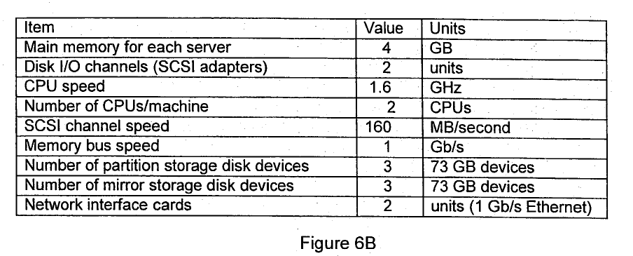

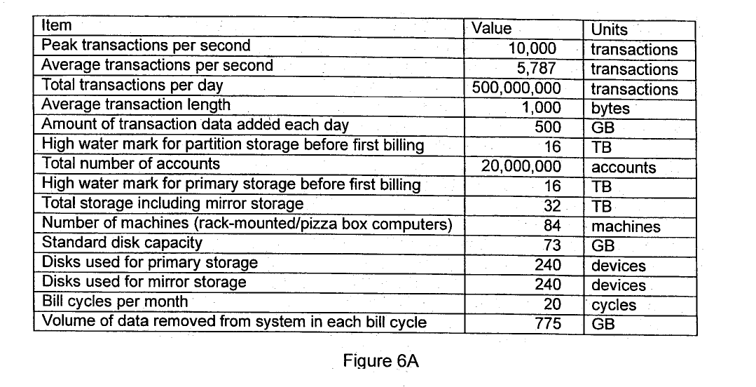

The description of the TSRS 110 of the present invention utilizes a reference configuration or system 200, shown in FIG. 5 as an example. The reference configuration 200 shown in FIG. 5 includes assumptions on number of accounts, transaction volumes, number of machines, number and capacity of disk storage devices and other technical specifications. These assumptions are set forth in FIG. 6A, and reference machine specifications are set forth in FIG. 6B. The TSRS 110 of the present invention is not limited to the reference configuration 200 described herein below. A TSRS 110 of the present invention is highly scalable, and the following description refers primarily to a particularly high volume reference configuration.

FIG. 5 shows a reference configuration 200 which is based upon the transaction storage and retrieval system (TSRS) 110 of the present invention. More particularly, FIG. 5 shows a reference configuration 200, including bill cycle machines and supporting TSRS 110 machines of the present invention.

In the reference configuration 200 shown in FIG. 5, for a telecommunications billing system, with 500,000,000 transactions per day, each transaction is 1000 bytes long, it's assumed that there are 20 billing cycles in a month, with the machine specifications in FIG. 6B, 4 machines are needed for each billing cycle. Each of the bill cycle 1 machines (machine 201-1, 201-2, 201-3, and 201-4) through bill cycle 20 machines (machine 220-1, 220-2, 220-3, and 220-4) is a component of the TSRS 110 of the present invention, as explained.

Each of the groups of 4 bill cycle machines corresponds to one bill cycle. There are 20 bill cycles. Thus, bill cycle 1 machines include machines 201-1, 201-2, 201-3, and 201-4; bill cycle 2 machines include machines 202-1, 202-2, 202-3, and 202-4; . . . ; and bill cycle 20 machines include machines 220-1, 220-2, 220-3, and 220-4. In addition, the reference configuration 200 includes spare machines SP-1, SP-2, SP-3, and SP-4.

Bill process machines B-1, B-2, . . . , B-12, which host the billing applications, are not part of the TSRS 110 of the present invention, but are shown for completeness. Each of the bill process machines includes, for example, 2 CPUs, as shown in FIG. 6B.

Configurations

Reference Configuration

Referring again to the reference configuration 200 shown in FIG. 5, each one of the machines that make up a partition holds a subset of the partition data and this subset is referred to as a subpartition. When an application server 106 finishes processing a transaction and contacts the TSRS 110 of the present invention to store the transaction data, a routing program directs the data to the machine that is assigned to that particular subpartition. The routing program uses the transaction's account number and thus ensures that transactions for the same account are stored in the same subpartition. The program is flexible and allows for transactions for very large accounts to span more than one machine.

In the reference configuration 200 shown in FIG. 5, data for each bill cycle, also called a partition, resides on 4 machines. Each machine holds a subpartition of the total bill cycle partition.

Each subpartition includes files limited in size to a site-specified value of 1, 2 or 4 gigabytes. Transactions for any specific account are directed to and stored in the same subpartition. Within a subpartition, transactions for a specific account may be found on any of the files that belong to the same subpartition.

The bill process is not run on the machines where the subpartitions are stored. Instead, on the day on which a partition is due for billing, the set of spare machines is configured to become the new home for new transactions that will arrive for that bill cycle number, in replacement of the current set of machines. All subpartitions on the current machines are then exported to the set of bill process machines and the current set becomes the new set of spares. The bill process machines in the figure are not, technically, part of the TSRS 110 of the present invention.

In the reference configuration 200 shown in FIG. 5, 4 TSRS 110 machines (such as bill cycle 1 machines) are used to store a partition, i.e., all accounts that belong in the same bill cycle or have an equivalent affinity with one another. Each of the 4 machines would normally be assigned to hold a specific subset of the partition, such that a specific account will always be stored in the same subpartition. In each of the 4 machines, one or multiple index structures can be used. All input/output processes (IOPs) on that machine would be concerned with only a subset of one bill cycle. Four spare machines (SP-1, SP-2, SP-3, and SP-4) would be used to replace the 4 machines that, on each bill cycle, may be temporarily busy with the extract process.

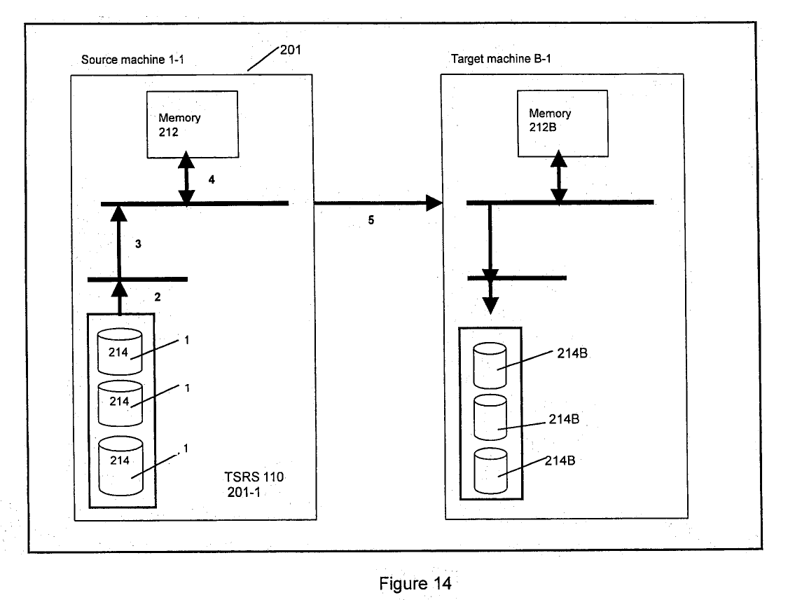

One consideration in the sizing for the reference configuration 200 is to limit the amount of time taken for the monthly process of extracting data for the bill process. An example of the calculations involved in reducing the length of the extract process to a manageable time of 30 minutes is shown in FIG. 14.

Very Large Bill Cycle Configuration

In a very large bill cycle configuration, there may be a business reason to define a very large bill cycle that exceeds the capacity of 4 machines. One single account or many accounts may be involved.

If a single account were to be involved, the scalability features of the TSRS 110 of the present invention introduces a randomization logic in the routing program so that the same account may be evenly distributed across the available TSRS 110 machines.

Additionally, for either 1 or more accounts, the number of spare TSRS 110 machines would have to be large enough to hold the largest bill cycle in the system and the number of TSRS 110 machines where the monthly batch processes are run would also have to be dimensioned appropriately.

Small Bill Cycle Configuration

In the small bill cycle configuration, the amount of data for a bill cycle is small and does not require 4 TSRS 110 machines. A single TSRS 110 machine may even handle more than one bill cycle.

The number of spare TSRS 110 machines and the number of batch processing machines would have to be only large enough to handle the largest cycle.

Components of a TSRS 110 Machine of the Present Invention

A TSRS system 110 refers to the software/hardware of many TSRS 110 computers.

Within each TSRS 110 machine (that is, computer), multiple independent processes, referred to as Input/Output Processors (IOPs), service the requests transmitted to the processes by their partner requestors. An IOP corresponds to a data subpartition, in the examples presented herein below.

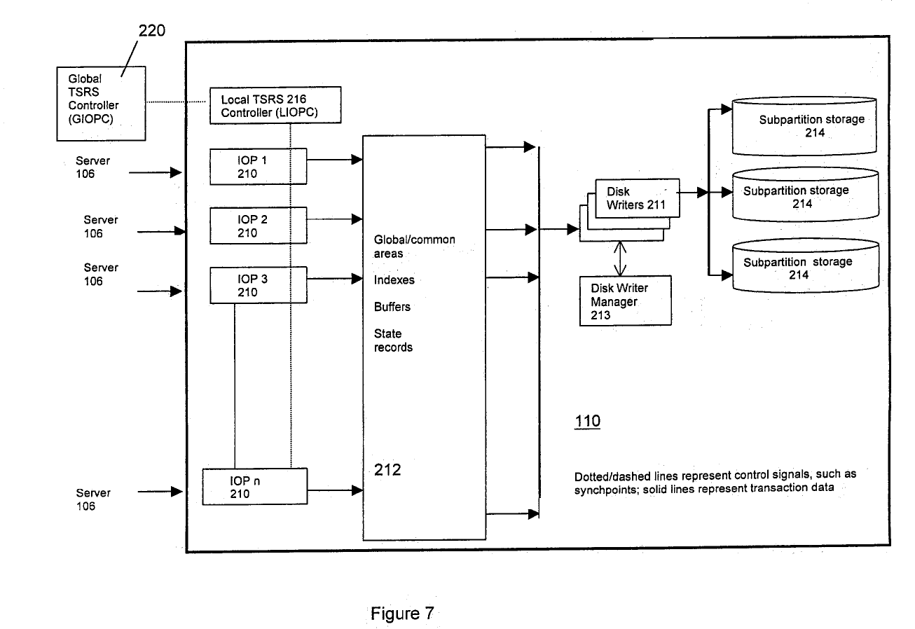

FIG. 7 shows a diagram of the components of the TSRS 110 of the present invention.

Each TSRS 110 machine includes a dedicated IOP 210 for each data subpartition. An IOP 210 is started when the TSRS system starts or on-demand as needed.

When application servers 106 perform their periodic synchpoints, the application servers 106 direct the TSRS 110 of the present invention to participate in the synchpoint operation. This participation by the TSRS 110 of the present invention ensures that the view of the application servers 106 of the transactions that they have processed and committed is consistent with the view of the TSRS 110 of the present invention of the transaction data that the TSRS 110 has stored.

Referring now to FIG. 7, all servers 106 in the system 100 send their processed transactions to the TSRS 110 machine for all accounts belonging to the current subpartition. In addition, other TSRS 110 machines are online to store transactions for other subpartitions.

There is one active IOP (input output processor) 210 for each data subpartition. The IOPs 210 store their transactions in memory buffers 212 according to the account's subpartition which are then asynchronously written to disk storage 214.

At synchpoint (explained in further detail herein below), when the TSRS 110 controller 216 receives the synchpoint signal, the affected buffers, if not already written to disk 214, are flushed to disk 214.

Within each subpartition file, the transactions are stored in their sequence of arrival to the TSRS 110.

Subsequent sections provide details on the various processing components within the TSRS 110 of the present invention.

Global Input Output Process Controller (GIOPC)

The Global Input Output Process Controller (GIOPC) 220 of the present invention is now explained. The GIOPC refers to the functionality which provides control and coordination for TSRS I/O processes. The GIOPC functionality can be organized in one or multiple components which provide centralized control for all TSRS machines I/O processes. In a multiple-component or decentralized implementation the GIOPC functionality reside in each application server/requestor 106. Regardless of the specific design of software components, the functionality of a GIOPC as well as the functionality of an LIOPC are encapsulated or hidden inside the requester logic and is not visible to the outside components. In the following descriptions, GIOPC and LIOPC are described as separate logical components.

Application Server Registration

When an application server 106 is started, the application server 106 obtains from the system configuration, which is locally set up on server 106, the address of a global TSRS 110 process referred to as the Global Input Output Process Control (GIOPC) 220. The application server 106 then contacts the GIOPC 220 to register itself as a requester.

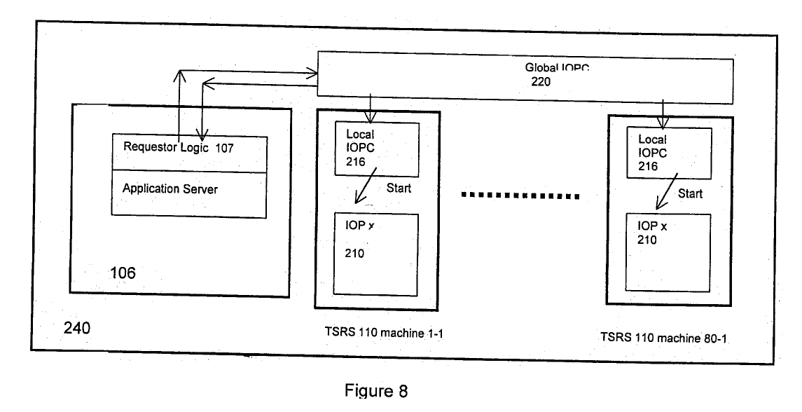

FIG. 8 shows a diagram 240 of application server 106 registration with the TSRS 110 of the present invention. Referring briefly to FIG. 8, at startup, application servers 106 registers themselves through requestor logic 107 with the TSRS 110 by contacting the Global IOPC (input/output process control) 220. The Global IOPC 220 is a single process that may reside on any of the TSRS 110 machines. The address of the Global IOPC 220 is available from the configuration files on every application server 106.

The Global IOPC 220 returns a list of the addresses of all TSRS 110 servers that the registering application server 106 may wish to contact later, in order to store processed transactions. These addresses may be an IP address and a port number if the TCP/IP communications protocol is used.

Referring again to FIG. 8, there is only one GIOPC 220 in the entire TSRS 110 system and this process can reside on any of the TSRS 110 machines. The address referred to is normally an IP address and a port number, since TCP/IP is the default communications protocol.

Application servers 106 often process a range of accounts and these accounts may fall into multiple subpartitions which may reside on different machines 110. When an application server 106 registers itself with the GIOPC 220, the application server 106 receives from the GIOPC 220 a list of addresses for all subpartitions of interest. This information is also obtained from the system configuration.

The GIOPC 220 does not start the IOPs 210 directly. The IOP 210 process on the local TSRS 110 machine, started when the machine was brought up, is told to begin listening for a connection request on the same port number that was also supplied to the registering application server 106.

The application server 106 will contact IOP 210 according to the data subpartition as soon as the application server 106 finishes processing the first transaction and wishes the application server's transaction data to be stored in the sequential database.

Another role played by the GIOPC 220 is the role of TSRS 110-level synchpoint subcoordinator, as explained in further detail herein below.

Input Output Processes (IOPs)

An IOP 210 is started on each TSRS 110 machine for each data subpartition. In this referenced design, an IOP corresponds to specific data partition and data subpartition. In other scenarios an IOP can be designed and configured for each or a combination of application servers/requestors 106.

Each IOP 210, as a dedicated process, attends only to its corresponding data partition and subpartition. The most common request is for the IOP 210 to store transaction data at the end of each transaction. When the IOP 210 receives the data, the IOP 210 passes the data along to the I/O interface 212 (shown in FIG. 7) which places the data in the memory buffer 212 corresponding to the subpartition 214 and disk device 214 where the transaction data should go. Enough buffers 212 are available to separate the transaction data accordingly in order to allow efficient storage and retrieval.

Although temporarily storing transaction data in memory, TSRS 110's logic will soon afterwards move the transaction data to a file on one of its disks 214. This is accomplished by sending a signal from the IOP 210 to a Disk Writer 211 thread, described in further detail herein below, which performs the actual write operation. This division of the task into 2 stages allows the IOP 210 to free the application server/requestor 106 much sooner, since the IOP 210 does not have to wait for the completion of the I/O operation and can quickly pick up the next transaction.

As part of TSRS 110's think-ahead features, files are written with consideration of their future use. Specifically, TSRS 110 anticipates the needs of the reader processes that will perform online queries or extract data for monthly batch processes. To accomplish this, the transaction data is further segregated into files corresponding to the subpartition. By defining subpartitions and therefore writing multiple files, the data is segregated in such a way that multiple job streams can operate on them, in parallel, at batch or query time.

An index structure corresponding to each partition 214 or subpartition is permanently maintained in memory 212 shown in FIG. 7 and includes a list of all keys or accounts in its domain. Each index entry points to the last transaction record written for the account and is therefore referred to as a back pointer. The back pointer specifies the file number and the offset of the record within that file. Within the transaction data files, the records for the same account are in turn chained together via back pointers.

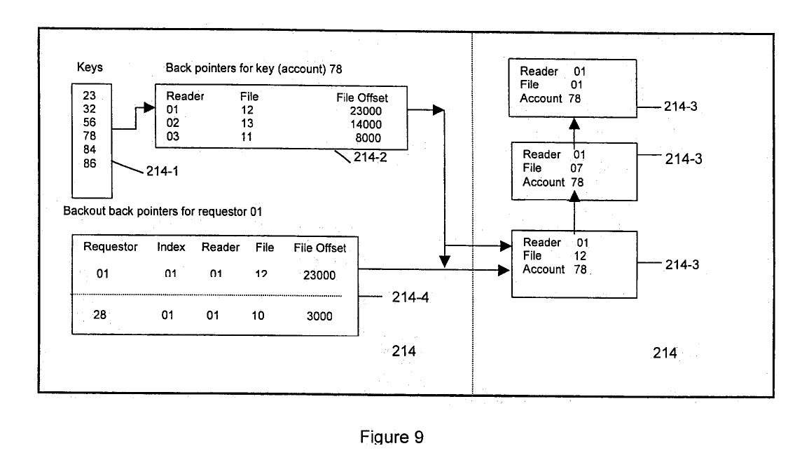

FIG. 9 shows a diagram of a partition or subpartition index structure. Referring now to FIG. 9, each TSRS 110 subpartition 214 is controlled by an in-memory index structure with an entry for each key or account 214-1. The in-memory index is particularly useful in querying the partition or subpartition. A back pointer 214-2 is kept for each account. This pointer points to the file and the offset within the file 214-3 containing the last transaction record for the account. Within each file, a transaction record, in turn, points to the previous transaction record for the account, which may be either within the same file or in a previous file.

To allow backouts in the case of a failing synchpoint, a separate table contains backout back pointers 214-4 by requestor number; if a backout command for a particular requestor is issued, this table points to the last record inserted on behalf of that requestor. By following the backout back pointer and the record chain within the files, it is possible to mark all affected records as deleted. The purpose of the backout pointers is to back out transactions in the case of a failed synchpoint, and these pointers are called backout back pointers. Within the transaction data files, the records for the same requestor are therefore also chained together via the backout back pointers.

At a high level, the transaction record layout is:

| | | |
|---|---|---|
| Back pointer | Backout back pointer | Transaction Data |

IOPs 210 are also responsible for the maintenance of a state file. This state file holds a record for each synchpoint that is performed. Essential entries in a state file record are:

| | | | |
|---|---|---|---|
| Synchpoint number | File number | File Offset | Current State |

The IOPs 210 control the high level aspects of input/output, such as opening a new file when none is open or the current file becomes full, keeping track of the current file number and the next offset to be used when writing new transactions and the current step in the synchpoint sequence. The synchpoint sequence is explained in detail herein below.

A transaction file is flushed and closed whenever it reaches a site-specified size. A new file is opened as a replacement for the file just closed. A file name contains information that identifies its partition or bill cycle, the subpartition and the file number. The file number is used to differentiate file names that belong to the same bill cycle and subpartition. The format of the file name is shown next:

| | | | |
|---|---|---|---|
| Base Name | Partition | Subpartition | File Number |

Disk Writer Manager and Disk Writer Threads

Referring again to FIG. 7, when TSRS 110 is started on a machine, a Disk Writer Manager 213 process is started. The Disk Writer Manager 213, in turn, starts several Disk Writer 211 threads, one Disk Writer thread 211 for each disk 214 available for storage of transactions. In the example of FIG. 7, each disk has a dedicated disk writer. In other cases, the TSRS 110 can be configured differently.

Storing transaction data by the TSRS 110 is performed in two stages. Synchronously with the execution of the transaction, the transaction data is merely transmitted to the corresponding IOP 210 within the TSRS 110 machine and placed in the designated buffer 212.

At a later point, in an asynchronous fashion, the Disk Writer threads 211 perform the actual writing of the transaction buffers to disk 214. As this operation is asynchronous, the operation does not lengthen the duration of an individual transaction but occurs in parallel with its execution.

Disk Writer threads 211 are dedicated threads, one for each disk on a TSRS 110 machine. Since one thread 211 per disk 214 suffices for the task, only one is used so as to avoid contention for the use of the device 214.

Disk writer threads 211 write buffers according to a priority scheme. Buffers that must be flushed due to a synchpoint request are written first. Next come the buffers with the largest amount of data in them. Finally, any buffer that has any data in the buffer is also written.

When there is nothing to be written, Disk Writer threads 211 enter a sleep cycle. The Disk Writer threads 211 are awakened from the sleep cycle by the IOPs 210, when new data arrives or other conditions change.

Local Input Output Process Controllers (LIOPCs)

After its initial role in starting an IOP 210 on the local TSRS 110 machine, when an application server/requestor 106 registers itself, the LIOPC 216 is also responsible for relaying synchpoint signals, on the TSRS 110 machine where the LIOPC 216 resides, whenever the LIOPC 216 is signaled by the global IOPC (GLIOC) 220 that a synchpoint is in progress.

Periodic Synchpoints

The TSRS 110 of the present invention is included in the synchpoint process. The TSRS 110 of the present invention is the enterprise's 100 central storage system. The TSRS 110 can be located on separate network machines and a communication protocol is used to store data and exchange synchpoint signals.

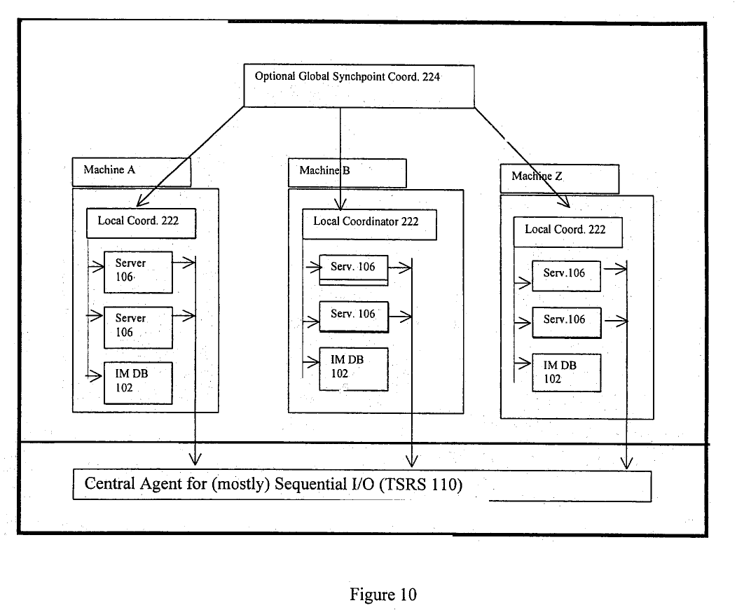

The flow of synchpoint signals is shown in FIG. 10. In a configuration in which the local synchpoint coordinator 222 keeps the time, the various machines (A, B, . . . Z) on the system 100 perform decentralized synchpoints. In decentralized synchpoints, synchpoints of all processes on each machine are controlled by the local synchpoint coordinator 222. Individual application servers 106 propagate the synchpoint signals to the TSRS 110 of the present invention, the enterprise's high volume storage.

In turn, the local synchpoint coordinator 222 may either originate its own periodic synchpoint signal or, conversely, it may be driven by an external signaling process that provides the signal. This external process, named the global synchpoint (or external) coordinator 224, functions to provide the coordination signal, but does not itself update any significant resources that must be synchpointed or checkpointed.

If an external synchpoint coordinator is used, the local synchpoint coordinators 222 themselves are driven by the external synchpoint coordinator 224 (or the global coordinator 124), which provides a timing signal and does not itself manage any resources that must also be synchpointed.

As shown in FIG. 10, an optional global synchpoint coordinator 224 transmits synchpoint signals to local coordinators 222. The local coordinators 222 transmit the synchpoint signals to the servers 106 and to the in-memory database 102. The servers 106 transmit the synchpoint signals to the TSRS 110. The TSRS 110 includes a global TSRS controller 220 (shown in FIG. 7), which receives the synchpoint signals transmitted by the servers 106. The global controller 220 (GIOPC) then transmits the synchpoint signal to each local contoller (LIOPC) 216.

The synchpoint signals shown in FIG. 10 flow to the servers 106, the in-memory database 102, the TSRS 110 of the present invention, to provide coordination at synchpoint.

In the high performance environment in which the TSRS 110 and the in-memory database 102 operate, synchpoints are not issued after each transaction is processed. Instead, the synchpoints are performed periodically after a site-defined time interval has elapsed. This interval is called a cycle.

A synchpoint signal is generated outside and upstream from the TSRS 110 of the present invention. The TSRS 110 needs only cooperate in achieving a successful synchpoint whenever a synchpoint signal is received indicating that a synchpoint is in progress.

The synchpoint follows a streamlined 2-phase protocol, where a “prepare to commit” (phase 1) signal is transmitted by the synchpoint coordinator to all synchpoint partners (including local coordinates 222 and local controllers 216); a positive response (or vote) must be received by the coordinator from all partners before the actual “commit” (phase 2) command is issued. Any negative vote at any point prevents a successful commit and all partners must in this case back out the work done during the cycle.

Since an individual IOP 210 operates synchronously with its partner requestor, the IOP 210 is essentially idle when a synchpoint signal arrives.

The arriving “prepare to commit” signal is propagated from the application coordinators 222 shown in FIG. 10 to the GIOPC 220, on to the LIOPC 216 and then to the IOP 210 for which the signal is intended.

The essential identifier for the synchpoint is the requester number. The same requestor may have uncommitted work on multiple TSRS 110 machines and the synchpoint must ensure that all work is either committed or backed out to achieve the consistency that synchpoints are designed to accomplish.

When multiple requestors are affected by a centrally-timed (or synchronized) synchpoint signal, multiple IOPs 210 may be affected on each machine (A, B, . . . , Z) but the signals to the multiple IOPs 210 arrive sequentially, due to the serial nature of the GIOPC 220 and LIOPC 216 processing.

A synchpoint “prepare to commit” signal is first processed by the IOP 210 because the IOP 210 includes the detailed logic to process the state file that maintains synchpoint state information.

In response to the “prepare to commit” signal, the affected Disk Writer threads 211 are instructed to flush their buffers. The buffers must be successfully written to disk 214 before a positive reply can be sent back to the coordinator 216. These buffers may contain transactions stored on behalf of requestors that are not involved in the current synchpoint. This is the normal mode of operation.

At all times during the cycle, buffers are written to disk 214 that contain transactions sent by all requestors, irrespective of the fact that those requesters may never commit those transactions due to some upstream malfunction. Should such a malfunction occur, TSRS 110 must have information safely externalized to disk 214 that will allow it to back out these transactions when instructed to do so.

This backout information is maintained in the index 214, in the state file records and in the transaction data files themselves. On successful completion of buffer flushing and writing of state records, a “ready to commit” response is sent back to the GIOPC 220 and through the GIOPC 220 to the application servers/requestors 106.

When the phase 2 signal arrives, the phase 2 signal may be a command to commit or back out all transactions for the cycle, depending on the votes of all the participating synchpoint partners.

If the resultant command is to commit the data, the IOP 210 completes the synchpoint processing, updates the state flag, records the file offset on the current file that marks the boundary of the data just committed, erases control information that will no longer be required such as the backout backpointer, prepares to accept new requests and, through the GIOPC 220, returns a “committed” response to the requestor 106.

If the resultant command is a back out, the IOP 210 will update the state record and mark all affected transactions with a logical delete indicator. This marking process uses the backout back pointer chain 214-4 of all transactions for the current requester 106. The transactions themselves remain physically on disk storage 214 but will be discarded in any later processing. A back out signal also prevents the affected IOP 210 from accepting new data for storage until recovery has been run and the state flag has been cleared.

Additional actions taken at synchpoint time related to index backup are discussed in the Recovery section herein below.

An explanation of transmitting the synchpoint signals to the in-memory database 102 is now presented.

The in-memory database 102's synchpoint logic is driven by an outside software component named the local synchpoint coordinator 222. The local synchpoint coordinator 222 is called local because the local synchpoint coordinator 222 runs on the same machine (A, B, or . . . Z) and under the same operating system image running the in-memory database 102 and the application servers 106.

When the synchpoint signal is received, the in-memory database 102, as well as its partner application servers 106, go through the synchpoint processing for the cycle that is just completing. Upon receiving this signal, all application servers 106 take a moment at the end of the current transaction in order to participate in the synchpoint. As disclosed herein below, the servers 106 will acknowledge new transactions only at the end of the synchpoint processing. This short pause automatically freezes the current state of the data within the in-memory database 102, since all of the in-memory database 102's update actions are executed synchronously with the application server 106 requests.

The synchpoint processing is a streamlined two-phase commit processing in which all partners (in-memory database 102 and servers 106) receive the phase 1 prepare to commit signal, ensure that the partners can either commit or back out any updates performed during the cycle, reply that the partners are ready, wait for the phase 2 commit signal, finish the commit process and start the next processing cycle by accepting new transactions.

Mutual Backup, Mirrorring and Failover

Maintaining consistency with the other components (shown in FIG. 2) of the suite of solutions for end-to-end support of high performance transaction systems 100, TSRS 110 machines are paired up so the TSRS 110 machines can serve as mutual backups. Each machine includes local disk storage to store its files and to hold a mirror copy of its TSRS 110 partner files.

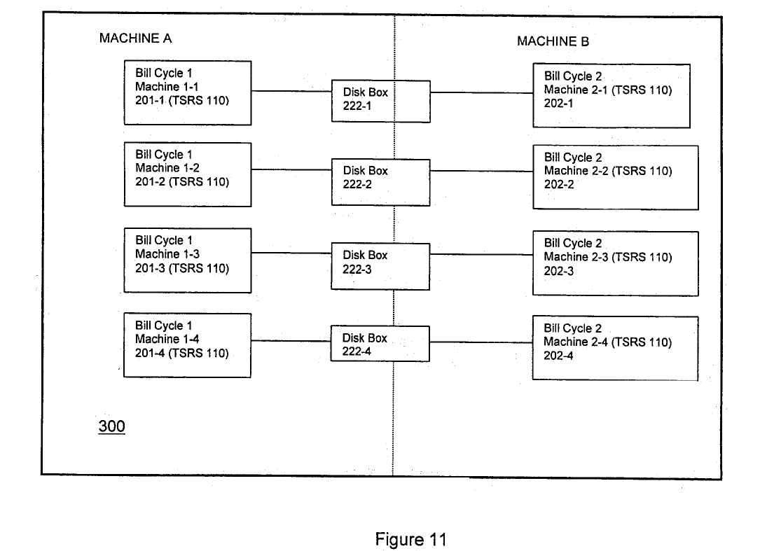

FIG. 11 shows a failover cluster 300 of TSRS 110 machines paired for mutual backup. As shown in FIG. 11, each TSRS 110 computer is paired with another TSRS 110 computer through a disk box 222. More specifically, TSRS 110 computer for bill cycle 1 (machine 1-1, or 201-1) is paired (or partnered) with TSRS 110 computer for bill cycle 2 (machine 2-1, or 202-1) through disk box 222-1. Likewise, TSRS 110 computer for bill cycle 1 (machine 1-2, or 201-2) is paired with TSRS 110 computer for bill cycle 2 (machine 2-2, or 202-2) through disk box 222-2. TSRS 110 computer for bill cycle 1 (machine 1-1, or 201-1) is paired with TSRS 110 computer for bill cycle 2 (machine 2-3, or 202-3) through disk box 222-3. TSRS 110 computer for bill cycle 1 (machine 1-4, or 201-4) is paired with TSRS 110 computer for bill cycle 2 (machine 2-4, or 202-4) through disk box 222-4.

The input/output (I/O) channels between the TSRS 110 computers and the disk boxes 222 are dedicated I/O channels. In this example, each TSRS 110 computer includes 3 disk devices, and each disk box 222 includes 6 disk devices. Each disk device has a capacity of 63 GB/disk of storage.

In this configuration, either machine will be able to quickly take over the responsibilities of its partner, in case its partner fails, in addition to continuing to carry out its own process. This will give operations more time to bring online a spare machine or repair the failing one.

Some disk devices in the Disk Box 222 are “owned” by one machine 201 or 202 but can also be accessed by its partner (202 or 201) in case of a takeover due to malfunction of the “owning” machine. Cross connections between the disk boxes make the disk devices accessible from both host machines 201, 202. In the example of FIG. 11, the machines 201 for bill cycle 1 back up the machines 202 for bill cycle 2. The internal disks are not shown in the diagram of FIG. 8. Each machine 201, 202 is responsible for the storage of a data subpartition for a different bill cycle but is capable of temporarily backing up its partner, in case its partner malfunctions.

Moreover, TSRS 110 machine pairs also engage in “hot-stand-by” of in-memory logs. The objective of the “hot-stand-by” is to allow fast take-over by the fail-over partner machine thus reduce the need for a full-fledged recovery. During the cycle, these updated segments (or after images) are kept in a contiguous work area in the TSRS' memory, termed the in-memory log. “Hot-stand-by” refers to the simultaneous, mutual storage of in-memory logs of TSRS 110 machines in their own memories and in the memories of their respective mirroring partners. The hot-stand-by of the TSRS 110 is similar in concept to the hot-stand-by of the in-memory database 102.

The “hot-stand-by” process updates the in-memory log of the original file/database and the in-memory log of the mirror file/database simultaneously by using a high-speed ETHERNET channel connecting the original file/database to the mirror file/database.

Two fast connections, such as high speed ETHERNET connections, provide dedicated channels for one TSRS 110 machine (machine A) to simultaneously update the in-memory log of its own TSRS 110 files and the in-memory log of the mirror copy of its TSRS 110 partner files (on machine B), and for its partner machine (machine B) to simultaneously update its in-memory log of TSRS 110 files and the first TSRS 110 machine (machine A).

In case of a failure of the TSRS 110 machine A, the back-up TSRS 110 machine B will be able to continue the process supported by the synchronized in-memory log and the TSRS 110 files on machine B. Machine B will use the in-memory log to restore the transactions since the last synchpoint, the process will then continue from the completion of the last transaction. Instead of rolling back to the last synchpoint, only the current transaction needs to be rolled back.

The failover cluster can be configured in other ways, multiple machines can be grouped together to from partner groups to provide mirroring databases and recovery capacity.

Database Backup

The TSRS 110 of the present invention receives the in-memory database 102 backup. The TSRS 110 of the present invention, for example, processes 10,000 transactions per second at peak, or ½ billion records per day. The TSRS 110 of the present invention achieves this processing power by being, essentially, a flat file, and without incurring the overhead of using a large-scale, general purpose database system. Thus, the TSRS 110 of the present invention allows for billing in, for example, a telephony billing application once per day, instead of once per month.

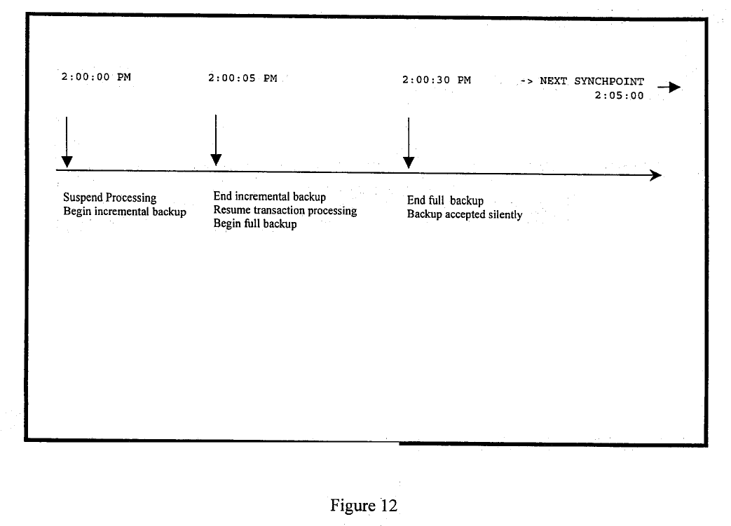

FIG. 12 illustrates the timing involved in a periodic backup process. More particularly, FIG. 12 illustrates incremental and full backups performed by the in-memory database 102, which performs backups to the TSRS 110 of the present invention.

The in-memory database 102's main functions at synchpoint are: (1) to perform an incremental (also called partial or delta) backup, by committing to disk storage the after images of all segments updated during the cycle, and (2) perform a full backup of the entire data area in the in-memory database's memory after every n incremental backups, where n is a site-specific number.

As shown in FIG. 12, at the end of each processing cycle, the in-memory database 102 performs an incremental backup containing only those data segments that were updated or inserted during the cycle. At every n cycles, as defined by the site, the in-memory database 102 also performs a full backup containing all data segments in the database. FIG. 8 shows the events at a synchpoint in which both incremental and full backups are taken.

The in-memory database's incremental backup involves a limited amount of data reflecting the transaction arrival and processing rates, the number and size of the new or updated segments and the length of the processing cycle between synchpoints. During the cycle, these updated segments (or after images) are kept in a contiguous work area in the in-memory database's memory, termed the in-memory log. The in-memory log can log both the “before” and “after” images of the database to enable roll-back or forward recovery. At the time of the incremental backup, these updates are written synchronously, as a single I/O operation, using a dedicated I/O channel and dedicated disk storage device, via a dedicated I/O thread and moving the data to a contiguously preallocated area on disk.

The care in optimizing this operation ensures that the pause in processing is brief. At the successful completion of the incremental backup, new transaction processing resumes, even if a full backup must also be taken during this synchpoint.

Every n cycles, where n is a site-specified number, the in-memory database 102 will also take a full backup of its entire data area. The in-memory database's index area in memory is not backed up since the index can be built from the data itself if there is ever a need to do so. Since the full backup involves a much greater amount of data as compared to the incremental backups, this full backup is asynchronous; it is done immediately after the incremental backup has completed but the system does not wait for its completion before starting to accept new transactions. Instead, it overlaps with new transaction processing during the early part of the new processing cycle. Although this operation is asynchronous, all the optimization steps taken for incremental backups are also taken for full backups.

During incremental backup of the in-memory database, the processing of transactions by the in-memory database is suspended. The processing of transactions by the application servers 106, though, is not suspended during full backup of the in-memory databases 102.

This so-called hot backup technique is safe because: (1) new updates are also being logged to the in-memory log area, (2) there are at this point a full backup taken some cycles earlier and all subsequent incremental backups, all of which would allow a full database recovery, and (3) by design and definition, the system guarantees the processing of a transaction only at the end of the processing cycle in which the transaction was processed and a synchpoint was successfully taken.

Recovery

Recovery involves temporarily suspending processing of new transactions, using the last full backup and any subsequent incremental backups to perform a forward recovery of the local and the central databases, restarting the server 106 processes, restarting the in-memory database 102 and TSRS 110 of the present invention and resuming the processing of new transactions.

Recovery processes may have to be run in case of power, disk storage or other hardware failure as well as in case processes stall or terminate abnormally, irrespective of whether or not an underlying hardware failure is clearly identified. The TSRS of the present invention engages in recovery without logging. That is, the TSRS database itself is a log.

The TSRS 110 recovery is designed to run quickly, despite the large volumes of data involved. A quick recovery process is ensured because paired machines are used for mutual backups and quick failover, mirror files are used, frequent synchpoints are included, a lazy index backup (explained herein below) is used during synchpoints, transaction record pointers are logged during the lazy index backup process, backout back pointers are used by the requester 106, monitors are used, and the overall architecture of the gap analyzer 108 is used.

Backing up indexes at synchpoint time is part of the recovery strategy. As previously explained, index structures in the TSRS 110's memory are volatile since the index structures must reflect, after each transaction is stored, the disk offset to the last transaction, both by account and by requester number. The back pointer, by account, allows the system 100 to maintain the chain of records for each account; the backout back pointer, by requester 106, allows the TSRS 110 to back out all transactions for a requester in case a synchpoint fails.

Because the index structures are volatile, the index should be written out frequently, at intervals specified by each site that coincide with one of the synchpoints. This will ensure that a reasonably recent index is available to be the starting point for the recovery process. This backup is termed a lazy backup because the backup is performed more or less leisurely as the IOP 210 begins to accept new requests for the new cycle and the disk system 214 must therefore be shared by the two tasks of backing up the index and storing new transaction data.

Meanwhile, as the index is in the process of being written to disk, specific account entries and pointers will change as a result of the new incoming transactions. In order to have all the data that the recovery process might need, the TSRS 110 will keep an in-memory log of the pointers to the new transaction records whenever the index is in the process of being written. When the index backup completes, the log is also saved to disk 214. The 3 separate pieces, (1) the backed up index, (2) the log of pointer changes and, (3) the transaction data itself, contain all the information required by a potential recovery process to recreate an index that was consistent with the data, at the last successful synchpoint. This would be the consistent state from which operations would resume after recovery. To recover a processing failure, the monitor may attempt to restart the primary machines' process, reboot the primary machine, or switch to the backup machine and start the failover process.

As is the case throughout the architecture of the system 100, the Gap Analyzer 108 process ensures that transactions that are backed out will eventually be reprocessed. Since synchpoints create a consistent state among all application servers/requestors 106 and the TSRS 110, transactions that are backed out from TSRS 110 files will also be backed out from the application servers' 106 lists of processed transactions. The Gap Analyzer 108, as explained in GAP DETECTOR DETECTING GAPS BETWEEN TRANSACTIONS TRANSMITTED BY CLIENTS AND TRANSACTIONS PROCESSED BY SERVERS, will detect the gaps and request retransmission of the missing transactions. This part of the recovery is built into the architecture of the system 100 and does not require additional support from the TSRS 110.

In the forward recovery process, the last full backup is loaded onto the local database (such as the in-memory database 102) and all subsequent incremental backups containing the after images of the modified data segments are applied to the database 102, in sequence, thus bringing the database 102 to the consistent state the database 102 had at the end of the last successful synchpoint.

A corresponding recovery process may have to be performed on the partition of the Transaction Storage and Retrieval System (TSRS) 110 of the present invention enterprise database that is affected by the recovery of the local in-memory database database to bring both sets of data to a consistency point. Failures in the in-memory database 102 machine or the in-memory database 102 machine process will typically affect only the subset of the database 102 that is handled by the failed machine or process.

Once these recovery operations are completed, processing of new transactions may resume.

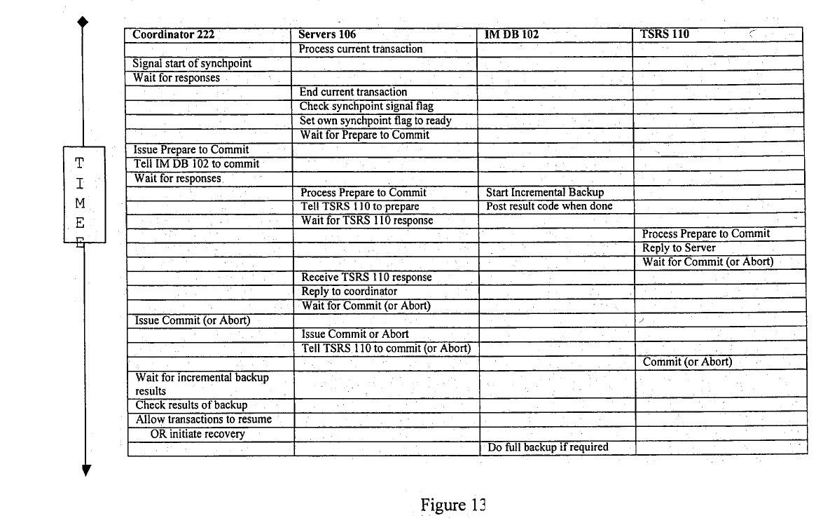

FIG. 13 shows a sequence of events for one processing cycle in a streamlined, 2-phase commit processing of the in-memory database 102, involving the TSRS 110 of the present invention and the servers 106. As shown in FIG. 10, the initial signaling from the Local Coordinator 222 to the Servers 106 is performed through shared memory flags. Moreover, the incremental backup is started in the in-memory database 102 as an optimistic bet on the favorable outcome of the synchpoint among all partners, and its results can be reversed later if necessary.

The results of the full backup are checked well into the next processing cycle and are not represented in the table of FIG. 13.

Monitoring

The architectural consistency of the TSRS 110 of the present invention includes use of shared storage that can be accessed by multiple processes. Operational data is often private to a process but statistical information, life sign indicators, signaling flags and other data can be shared and can be used to monitor all processes. A combination of local agents that inspect the life signs of the local TSRS 110 machine and a global monitor (that is, the GIOPC 220) that receives data from the local agents (LIOPC), a comprehensive monitoring system allows operations to respond immediately to signs of trouble and initiate actions to clear problems.

Example of Critical Timings in Exporting Bill Cycle Partition Data on the Billing Date

FIG. 14 shows an example of critical timings involved in exporting bill cycle partition data to a target machine on the billing date.

Once a month, the data from a bill cycle partition must be transferred from their home machines (sources, such as TSRS 110 machine 1-1, or 201-1) to corresponding billing process machines (targets, such as target machine B-1). The time to perform this transfer depends on the speed of the various components. In the reference configuration discussed herein above with reference to FIG. 4, this transfer is done in parallel between 4 source and 4 target machines. For the discussion that follows, reference is made to the numbers in the FIG. 11.

Each disk device 214 (1) can transfer data to its controller at the rate of 50 MB/second; the 3 disks, operating in parallel, have a total transfer capacity of 150 MB/second.

Each SCSI channel (2) has a carrying capacity of 160 MB/sec and is thus able to accommodate its 3 disks transferring data concurrently.

The PCI (I/O) bus (3) has a capacity of 508.6 megabytes per second and can thus handle the stream from the disk system 214.

Along its path, the data goes through the memory bus (4), with a rating of 1 GB/second. Since the data will be stored in memory 212 and retrieved immediately thereafter in order to be sent over the network (5), only half of this bandwidth can be used, or 500 MB/second.

A 1-Gb/second ETHERNET connection, according to published benchmarks, can transfer data at a speed of 0.9 Gb/s or 112.5 MB/second, between the source and target machines.

The overall time taken for the extract is therefore constrained by the narrowest bandwidth available along the transmission path, or 112.5 MB/second for the ETHERNET link (using a single ETHERNET link).

Each source machine 201 can thus transfer its subpartition of 194 GB in 1724 seconds, or about 30 minutes. The four machines 201-1, -2, -3, and -4 operate in parallel and therefore transfer the whole bill cycle partition in approximately the same time.

In the high performance computer system 100, shown in FIG. 2, there is coordination between the major components (such as shown in FIG. 2) to ensure commit integrity. If there is an abnormal end to a record update, for example, then, because of data dependence, all updates are backed out throughout the high performance computer system 100. Thus, during each 5-minute interval of time between commit points, the high performance computer system 100 in which the in-memory database 102 is included, processes 100 transactions per second×60 seconds per minute×5 minutes=30,000 account updates, which corresponds to approximately 30 megabytes (MB) of data.

In contrast, in the related art, all components of a computer system wait until a commit point is reached to refer to existing records, which locks existing records for a longer period of time and slows performance.

Possible uses of the present invention include any high performance data access applications, such as real time billing in telephony and car rentals, homeland security, financial transactions and other applications.

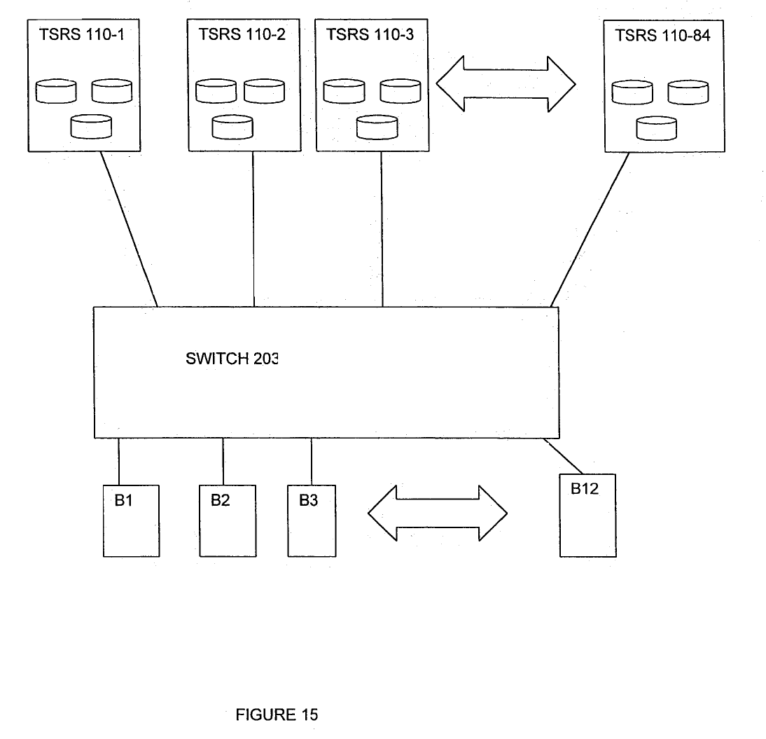

A brief discussion of business processing requirements being satisfied by the TSRS 110 of the present invention is presented, with reference to FIGS. 15-18.

FIG. 15 shows an example of transaction storage and retrieval systems of the present invention with disk devices configured to meet a business process requirement.

Each of the bill cycle machines and the spare machines corresponds to one TSRS 110 of the present invention and includes 3 disks. Each of the 3 disks includes a storage capacity of 64 GB/disk. Therefore, in each grouping of 4 TSRS 110 computers in a bill cycle, there is approximately 775 GB of data stored across all 12 disks.

Also shown is a SWITCH 203, which is an ETHERNET GIGABYTE Switch or a MYRANET switch, coupling the bill cycle machines, the spare machines, and the bill process machines.

A goal, which is met by using the TSRS 110 of the present invention, is to meet the business processing requirement of processing all transactions in 1.5 hours or less.

Each pathway connecting each disk of each TSRS 110 computer to switch 203 needs 150 MB/second potential bandwidth, and has 34 GB/sec. speed. For the 3 disks included in each TSRS 110, then, there is 3×34 GB/sec, or 100 GB/sec. data transfer rate. The 100 GB/sec. transfer rate is met by each of the two above-mentioned switches.

Each TSRS 110 bill cycle machine (having 3 disks) transmits its data to 3 bill process machines because one piece of data is written to each member of a team of machines.

For each bill cycle, data is extracted and sorted, and 12 bill process machines B1-B12 optimizes the speed at which this is accomplished. Since the speed is optimized for 12 bill process machines, then adding an additional 12 (for a total of 24) bill process machines will not increase the speed at which the data is extracted and sorted.

Since each bill cycle machine (of which there are 4 bill cycle machines in a bill cycle) has 3 disks, then extracting and transmitting data from the disks of the bill cycle machines (of which there are 12 disks in each bill cycle) to 12 bill process machines optimizes the system 200 for load balancing.

Additional, later jobs would run faster if the above-mentioned configuration included 24 bill process machines instead of 12 bill process machines.

Since each bill process machine B1-B12 includes 2 CPUs, then 2 files are extracted for each bill process machine and 2 instances of billing jobs are executed in parallel by each bill process machine. The output of each bill process machine is 24 files (in 1.5 hours), and, thus, the billing cycle is considered to be run “24 wide”.

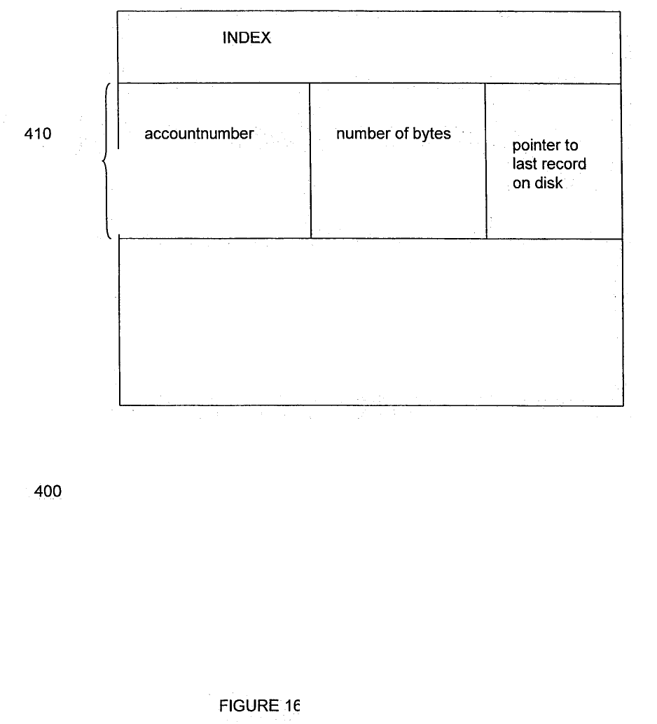

FIG. 16 shows an example of the contents of an index file 400 of the transaction storage and retrieval system of the present invention.

An index file stored on each TSRS 110 machine indicates the number of records stored on that TSRS 110 machine, and, based on the index, the TSRS 110 machine determines to which bill process machine to send the records for sorting. A counter is then updated. There is one extract process for each disk in each TSRS 110 machine, which goes through all files on the disk, looks up the bill process machine, and determines to which bill process machine each file should be written. Thus, load balancing in the system 200 is based upon the number of bytes already allocated to each bill process machine.

That is, the system 200 reads a record from the bill cycle machine, looks up in the index the account and the number of records per account, and sends the record to the bill process machine. The index of the record 410 includes the account number, the number of bytes of data collected in 1 month (which is the number of records×1000), and a pointer to the last record. The index, then, tracks where to write a total of 6 files (2 files per bill cycle machine), and the TSRS 110 builds an account table in memory, which includes which bill process machine to which the record will be transmitted. Transmission to the bill process machine may be accomplished, for example, using a TCP/IP connection.

An example of logic included in a routing program meeting the above-mentioned business processing requirements includes reading in 2 GB of data from the bill cycle machines, sorting the data, and writing the data out. Taking load balancing into consideration, approximately 32 GB of data is read. Since each disk in each bill cycle machine holds 64 GB of data, then to sort the data stored on the equivalent of one disk requires 2 sorts of 32 GB of data per sort.

If 64 GB of data are sorted in ½ hour, then 128 GB of data is sorted in 1 hour. If the data is sorted 2 GB at a time, then 16 chunks of 2 GB data is required to be sorted to sort 32 GB of data. If it takes 30 minutes of read time (assuming a 100 GB ETHERNET connection), 15 minutes of memory sort time, and 5 minutes to write out files in a striped manner at 100 MB/second (for a total of 50 minutes for 16 files), and if it takes an additional 10 minutes to merge the files, then it takes a total of 60 minutes to extract and sort (which is less than the 1 ½ hour budget) the 16 input files into one output file. Therefore, if the 2 GB files are divided into 17 pieces (corresponding to the 16 input files and the one output file), then 100 MB/piece is required for a transfer rate. Repositioning the arm of the disk to stream in 100 MB of data requires 16² repositionings, for approximately 300 repositionings. If each repositioning requires 5 milliseconds (ms), then only 1500 ms of time is required to accomplish the repositionings of the arm. If in one pass, all 32 GB of data is read, and in a second pass, all 32 GB of data is written, then 64 GB of data is processed. If the 64 GB of data is processed at 50 MB/sec, then 20 minutes is required to process the 64 GB of data. If the data is striped, then divide the 20 minutes by 2 and only 10 minutes is required to process the data.

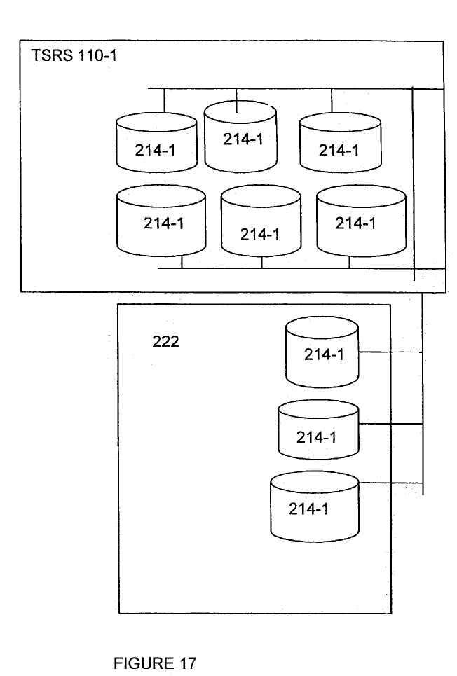

FIG. 17 shows a transaction storage and retrieval system of the present invention coupled to a disk box.

In the example of FIG. 17, one workfile (WF1A) is stored across 2 of the disks in the TSRS 110 of the present invention, another workfile (WF2A) is stored across another 2 of the disks in the TSRS 110 of the present invention, a third workfile (WF1B) is stored across yet a different 2 of the disks in the TSRS 110 of the present invention, and, lastly, a fourth workfile (WF2B) is stored across 2 of the disks of the disk box 222. Each of the disks of the TSRS 110 of the present invention interfaces to a SCSI controller, and the disks of the disk box 222 are coupled to a SCSI controller.

If each workfiles WF1A and WF2A requires 100 MB/sec. to sort, and each of workfiles WF1B and WF2B requires 100 MB/sec. to sort, then a total of 400 MB/sec. of processing power is required to sort the workfiles. The example of the TSRS 110 configuration coupled to the disk box 222 shown in FIG. 17 provides 508 MB/sec. of processing power, thus exceeding the business application requirements set forth.

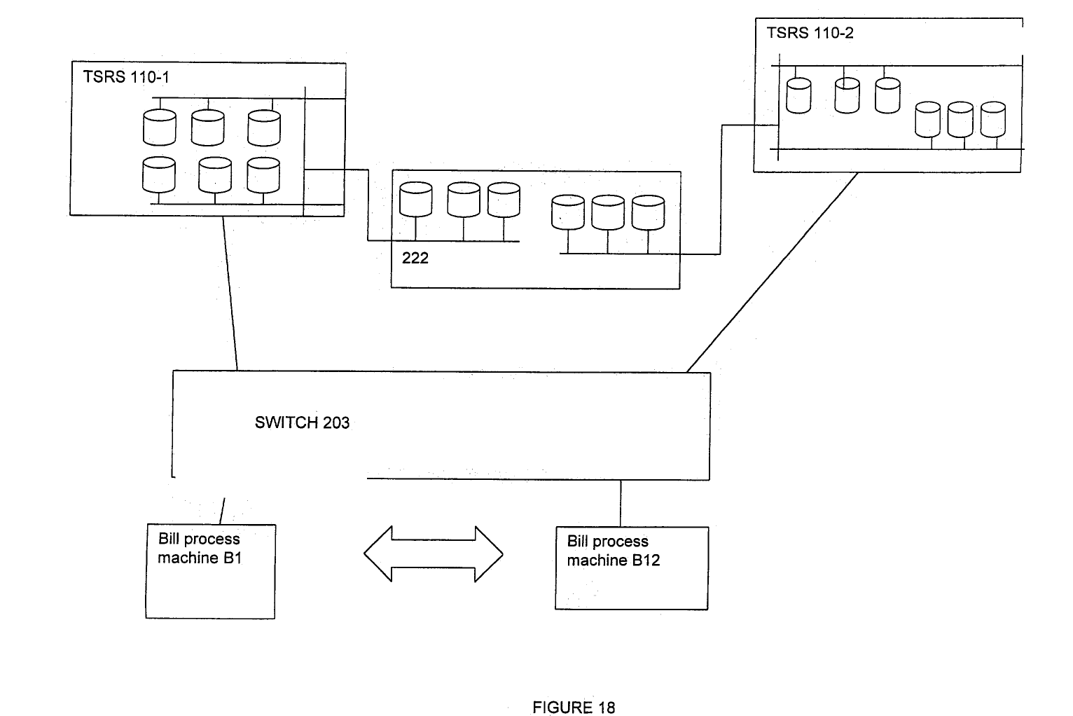

FIG. 18 shows a pair of transaction processing and retrieval systems 110-1 and 11-2 of the present invention coupled to a disk box 222 and to a switch 203. As shown in FIG. 18, each of the transaction processing and retrieval systems 110 of the present invention is allocated 3 of the disks 214 of the 6 disks included in the disk box 222. The switch 203 is coupled to bill process machines B1-B12.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. An apparatus comprising:
a high performance transaction storage and retrieval system supporting an enterprise application requiring high volume transaction processing using commodity computers by organizing transaction data into partitions, sequentially storing the transaction data, and sequentially retrieving the transaction data, the transaction data being organized, stored, and retrieved based upon business processing requirements.

2. The apparatus as in claim 1, wherein the high performance transaction storage and retrieval system is linearly scalable.

3. The apparatus as in claim 1, wherein the high performance transaction storage and retrieval computers comprise disk devices, each of the disk devices storing a subpartition, a combination of subpartitions, or a fraction of a subpartition of data.

4. The apparatus as in claim 3, wherein the high performance transaction storage and retrieval computers comprise disk writers, the disk writers respectively corresponding to the disk devices.

5. A transaction storage and retrieval system comprising servers and further comprising:
input/output processes corresponding respectively to the servers and receiving transaction data from the servers;
a memory, coupled to the input/output processes, receiving the transaction data from the input/output processes and storing the transaction data;
disk writers with dedicated threads for corresponding disks; and
subpartition data storage, coupled to the disk writers, said disk writers reading the transaction data from the memory and storing the transaction data in the subpartition storage, said subpartition storage being organized as flat files, each subpartition storage storing data corresponding to a subpartition of the transaction data.

6. A transaction storage and retrieval system comprising servers and further comprising:
input/output processes corresponding respectively to data partitions or data subpartitions;
a memory, coupled to the input/output processes, receiving the transaction data from the input/output processes and storing the transaction data;
disk writers providing dedicated thread for corresponding disks; and
subpartition data storage, coupled to the disk writers, said disk writers reading the transaction data from the memory and storing the transaction data in the subpartition storage, said subpartition storage being organized as flat files, each subpartition storage storing data corresponding to a subpartition of the transaction data.

7. The transaction storage and retrieval system of claim 5, wherein the transaction storage and retrieval system includes a global controller, said transaction storage and retrieval system further comprising a local controller receiving a synchpoint signal from the global controller and transmitting the synchpoint signal to the input/output processes.

8. The transaction storage and retrieval system of claim 7, wherein the global controller function can be encapsulated into the servers, or the said global controller function can be kept in a global control component used by all other servers and I/O processes.

9. The transaction storage and retrieval system of claim 5, wherein the memory comprises an index file storing locations of files corresponding to an account number.

10. The transaction storage and retrieval system of claim 5, further comprising a routing program determining data placement into partitions.

11. The transaction storage and retrieval system of claim 10, wherein the routing program determines the data placement based upon load balancing of the disks storing the partitions.

12. The transaction storage and retrieval system of claim 9, wherein the data comprises business data and the routing program determines the data placement based upon grouping of the business data for subsequent business transactions.

13. An apparatus coupled to servers inputting transaction data, said apparatus comprising:
groups of transaction storage and retrieval computers, comprising servers, each of the transaction storage and retrieval systems comprising:
input/output processes corresponding respectively to data partitions and subpartitions
a memory, coupled to the input/output processes, receiving the transaction data from the input/output processes and storing the transaction data;
disk writers coupled to the memory and corresponding respectively to the servers; and
subpartition storage, coupled to the disk writers, said disk writers reading the transaction data from the memory and storing the transaction data in the subpartition storage, said subpartition storage being organized as flat files, each subpartition storage storing data corresponding to a subpartition of the transaction data;
a switch, coupled to the transaction storage and retrieval system, receiving the transaction data from the transaction storage and retrieval system; and
process computers, coupled to the switch, receiving the transaction data from the switch, said process computers processing the transaction data based upon the groups of the transaction storage and retrieval systems.

14. The apparatus as in claim 13, wherein the groups of transaction storage and retrieval system include multiple transaction storage and retrieval machines.

15. The apparatus as in claim 14, wherein each of the transactions storage and retrieval machines in the group comprises multiple disks.

16. The apparatus as in claim 15, wherein the process computers include dedicated process computers processing the transaction data received from the each disk of each transaction storage and retrieval machine.

17. The apparatus as in claim 16, wherein the transaction storage and retrieval machines are grouped according to certain transaction characteristics, and the process computers correspond to the respective business application process computers.

18. The apparatus as in claim 13, wherein the transaction storage and retrieval machines are grouped according to cetain transaction characteristics, and the process computers correspond to the respective business application process computers.

19. The apparatus as in claim 13, further comprising disk boxes, wherein a plurality of the transaction storage and retrieval machines being organized into a group through the disk boxes, and the group of transaction storage and retrieval systems storing a mirror copy of each other.

20. The apparatus as in claim 19, wherein the transaction storage and retrieval computers are organized into groups based upon certain transaction characteristics.

21. The apparatus as in claim 13, further comprising spare machines organized into a group corresponding to a group of the transaction storage and retrieval system machines.

22. The apparatus as in claim 13, wherein each of said transaction storage and retrieval systems further comprising an in-memory index or multiple in-memory indices.

23. The apparatus as in claim 22, wherein each of said transaction storage and retrieval computers engaging in recovery without using a transaction log file or a full database log file.

24. A transaction storage and retrieval system as in claim 5, further comprising a failover configuration including a mirroring database and an in-memory log, wherein a mirroring database's in-memory log is synchronized with the in-memory log of a primary database, enabling the transaction storage and retrieval system to roll back only one transaction in case of a system failure.

25. An apparatus as in claim 13, further comprising a failover configuration including a mirroring database and an in-memory log, wherein a mirroring database's in-memory log is synchronized with the in-memory log of a primary database, enabling the transaction storage and retrieval system to roll back only one transaction in case of a system failure.

26. The transaction storage and retrieval system of claim 6, wherein the transaction storage and retrieval system includes a global controller, said transaction storage and retrieval system further comprising a local controller receiving a synchpoint signal from the global controller and transmitting the synchpoint signal to the input/output processes.

27. The transaction storage and retrieval system of claim 26, wherein the global controller function can be encapsulated into the servers, or the said global controller function can be kept in a global control component used by all other servers and I/O processes.

28. The transaction storage and retrieval system of claim 6, wherein the memory comprises an index file storing locations of files corresponding to an account number.

29. The transaction storage and retrieval system of claim 6, further comprising a routing program determining data placement into partitions.

30. The transaction storage and retrieval system of claim 29, wherein the routing program determines the data placement based upon load balancing of the disks storing the partitions.

31. The transaction storage and retrieval system of claim 28, wherein the data comprises business data and the routing program determines the data placement based upon grouping of the business data for subsequent business transactions.

32. A transaction storage and retrieval system as in claim 6, further comprising a failover configuration including a mirroring database and an in-memory log, wherein a mirroring database's in-memory log is synchronized with the in-memory log of a primary database, enabling the transaction storage and retrieval system to roll back only one transaction in case of a system failure.
